(19) United States
(12) Patent Application Publication
(10) Pub. No.: US 2013/0300011 A1
(43) Pub. Date: Nov. 14, 2013

(54) METHOD FOR PRODUCING MOLDING DIE, WAFER LENS, AND OPTICAL LENS

(71) Applicant: Akihiro Fujimoto, Hino-shi (JP)

(72) Inventor: Akihiro Fujimoto, Hino-shi (JP)

(21) Appl. No.: 13/981,013

(22) PCT Filed: Jan. 23, 2012
(86) PCT No.: PCT/JP2012/051375

§ 371 Date: Jul. 22, 2013

(30) Foreign Application Priority Data
Jan. 25, 2011 (JP) 2011-013323

(51) Int. Cl. B29D 11/00

(52) U.S. Cl. CPC B29D 11/00
USPC 264/2.5

(57) ABSTRACT

Since a space between one of a plurality of recessed portions 42c formed in a sub-master substrate 42 and a first molding surface 31 of a master die 30 is filled with a first resin material 41b, the thickness of a sub-sub-master resin layer 51 formed on the entire sub-master substrate 42 can be made relatively small while ensuring the thickness of the first resin material 41b which faces the first molding surface 31. Therefore, warpage of the sub-master substrate 42 caused by the sub-sub-master resin layer 51 can be prevented while easily increasing the positioning accuracy of the master die 30. By providing an annular step 32 in the periphery of the first molding surface 31, a residual film portion 44 which is an outer edge portion of the sub-sub-master resin layer 51 can be formed between the step 32 and the periphery of a recessed portion 42c. A local increase in thickness of the sub-sub-master resin layer 51 is prevented by the residual film portion 44 and, therefore, the thickness of a finally obtained wafer lens 10 can be made small.

### TECHNICAL FIELD

The present invention relates to a method for producing a molding die used to produce a wafer lens which includes a plurality of optical lenses and for producing a wafer lens and optical lenses using this molding die. More particularly, the present invention relates to a method for producing a molding die obtained by forming a resin-made shape transfer layer by transferring on a substrate and a method for producing a wafer lens and optical lenses using this molding die.

### BACKGROUND ART

Recently, obtaining individual optical lens by producing a wafer-shaped plate member (wafer lens) in which multiple optical lenses are formed and then dividing into single pieces the optical lenses has been studied. As a method for transferring micro-optical parts on a wafer scale, producing a first generation reproduction tool made of, for example, resin by transferring with repeated use of a small master die, then, producing a plurality of sub-master dies from the first generation reproduction tool, and producing a plurality of second generation reproduction tools provided with multiple micro-optical elements from the sub-master dies has been proposed (see Patent Literature 1). The wafer-shaped first generation reproduction tool obtained by this method is a molding die for producing a subsequent molded product and is a tool constituted by a resin-made shape transfer layer formed on a substrate.

In addition, as a method for forming a molding die, which is used for producing a wafer lens and in which a resin-made shape transfer layer is provided on a substrate, in order to, for example, prevent unsuccessful mold release at the time of releasing a molded product from a master substrate, a method for producing a molding die by forming a plurality of recessed portions which are closed inside them on a substrate for molding die, injecting a resin material into each of the recessed portions, and then pressing the recessed portions with a master die has also been proposed (see Patent Literature 2).

Recently, versatility of small-sized optical lenses has been increased and it has been required that the optical lenses have intended accurate lens shape so that desired optical performance may be demonstrated. In order to improve the optical performance, a plurality of optical lenses may be stacked. From these viewpoints, it is required that the thickness of a resin layer of the wafer lens is not excessively large. If the thickness of the resin layer of the wafer lens is excessively thick, it is possible that desired optical performance is not demonstrated or that warpage, deformation and the like may be caused in the wafer lens due to increased stress of the resin layer. Further, there is a possibility that the entire size is increased when the optical lenses are stacked. There is also a problem that the material cost may be increased and the curing time may become longer.

In order to prevent the thickness of the resin layer of the wafer lens from being excessively large, it is required to produce the molding die which includes the resin-made shape transfer layer described above in consideration of this and it is necessary that molding is performed with the master die being brought close to the substrate for molding as much as possible at the time of producing the molding die. This is because, if the resin-made shape transfer layer of the molding die becomes thick, it is not possible to reduce the thickness of the resin layer of the finally obtained wafer lens since the shape is transferred also to a molded product molded using this molding die.

Typically, it is necessary to press the master die against the substrate for molding die with large pressure to bring the master die close to the surface of the substrate for molding die in a state in which a resin material is disposed between the master die and the substrate for molding die. Therefore, the size of a production device becomes large and it becomes difficult to ensure the positioning accuracy of the master die. Further, if the master die is inclined for some reason, there is also a possibility that the master die may be in contact with a sub-master substrate, thereby damaging the sub-master substrate and the master die. It is also considered that the resin material overflows from the master die at the time of molding and the overflowed portion forms an unintended shape. Especially if recessed portions which are closed inside them are provided on a substrate for molding die as in Patent Literature 2, the space between the peripheral edges of the recessed portions and a peripheral edge of the master die is significantly narrow at the time of molding and, therefore, a possibility that resin overflows is even more increased due to, for example, variation in the resin amount injected in the recessed portions and minor errors in distance between the master die and the substrate for molding die. If the distance among each molding position by the master die is shortened in order to increase the number of optical lenses to be obtained from a single wafer lens, the overflowed resin may gather and rise, thereby forming projections. Therefore, a possibility of producing an unintended shape is even further increased. Further, in a case in which recessed portions which are closed inside them are provided on a substrate for molding die as in Patent Literature 2, if a resin amount is reduced so that resin does not overflow, shortage of resin may occur and a space may remain in the recessed portions. Therefore, when a subsequent molded product is obtained using this molding die, a position corresponding to the space has an unintended projection shape. Such an abnormal shape may cause inconvenience, such as unsuccessful mold release, and is thus not desirable. After all, in the related art technique, there has been a problem that reducing the thickness of the resin layer of the wafer lens is difficult while eliminating the inconvenience at the time of molding.

From the viewpoint of improving mass productivity or prolonging the life of the master die, such a problem becomes noticeable especially in a case where a die in which a plurality of shapes corresponding to those of the optical lenses are arranged is used as the master die. This is because, for example, higher accuracy is required for inclination adjustment with respect to the substrate for molding die and the amount of used resin is increased, due to the increased size of the master die.

### CITATION LIST

### Patent Literature

1: U.S. Patent Application Publication No. 2006/0259546

2: Japanese Unexamined Patent Application Publication No. 2010-102312

### SUMMARY OF INVENTION

An object of the present invention is to provide a method for producing a molding die which has an intended shape and by which a wafer lens on which optical lenses which may demonstrate desired optical performance are formed may be produced.

Another object of the present invention is to provide a method for producing a wafer lens and optical lenses which are highly precise using a molding die obtained by the method for producing described above.

### Solution to Problem

To solve the above problem, a method for producing of a molding die according to the present invention comprises: a first process in which a master die including a molding surface on which multiple shapes corresponding to shapes of optical lenses are arranged and including an annular step in the periphery of the molding surface is arranged to be opposite to a first substrate for molding die including, on a flat surface thereof, a plurality of recessed portions which are greater in size than the molding surface and are closed inside thereof, so that the entire molding surface faces a single recessed portion among the plurality of recessed portions; a second process in which the master die and the first substrate are brought relatively close to each other and in which a space between the molding surface and the first substrate (a recessed portion) is filled with a first resin material so that the recessed portion and the step are covered; a third process in which the first resin material between the molding surface and the first substrate is cured; and a fourth process in which the master die is released, wherein a molding die including a resin-made shape transfer layer is obtained by moving the master die toward another recessed portion among the plurality of recessed portions and performing the first to fourth processes repeatedly.

According to the method for producing described above, by providing the annular steps in peripheries of the molding surface, a space into which the resin material may spread can be formed between the step and the periphery of the recessed portion. Therefore, even if the molding surface of the master die are disposed close to the height of the flat surface of the first substrate, since the space is filled with the resin material, occurrence of abnormal shapes caused by overflow or lack of the resin material can be avoided.

According to particular aspect or focus of the present invention: a plurality of rectangular molding areas corresponding to the molding surfaces are set on the first substrate by the master die; and regarding a distance X of the master die in two adjoining molding areas among the plurality of molding areas, letting an area of the master die including a retreated surface of the step and the molding surface be denoted by A, letting an effective area of the master die corresponding to the molding surface be denoted by B, letting a thickness of a residual film portion corresponding to a distance between the retreated surface of the step and the flat surface of the first substrate during the third process be denoted by C and letting a thickness of an effective structure corresponding to an average distance between the molding surface and a bottom surface of a recessed portion which faces the molding surface during the third process be denoted by D, the following relational expression holds:

X≧√{B+(0.05×[B×D+[A−B]×C]+0.005×A)/C}−√A.

In this case, it is possible to prevent that two adjacent molding areas come close to each other and that the resin layer rises between the molding areas to form a projection.

According to another aspect, in the third process, the thickness of the residual film portion corresponding to the distance between the retreated surface of the step and the flat surface of the first substrate is shorter than a distance between a portion of the molding surface furthest from the first substrate and the flat surface of the first substrate in the direction vertical to the flat surface. In this case, the thickness of the residual film portion itself may be reduced.

According to further another aspect, in the third process, a position of the molding surface nearest to the first substrate and the flat surface of the first substrate substantially coincide with each other in the direction vertical to the flat surface. In this case, the depth of the recessed portions may be reduced to the minimum and the thickness of the resin material which faces the molding surfaces can become appropriate thickness.

According to further another aspect, the molding surface of the master die includes a flat flange transfer surface which is provided in the periphery of a portion having a shape corresponding to the shape of the optical lens.

According to further another aspect, in the molding surface of the master die, for example, an optical transfer surface recessed is formed.

According to further another aspect, in the second process, a space between the molding surface and the first substrate is filled with the first resin material disposed on at least one of the master die and the first substrate so that the recessed portion and the step portion are covered with the first resin material by bringing the master die and the first substrate relatively close to each other.

According to further another aspect, a second molding die is obtained by using the resin-made molding die obtained by the method for producing a molding die above as a first molding die, filling a space between the first molding die and a second substrate for molding die with a second resin material; curing the second resin material, and releasing the first molding die. In this case, the second molding die is a molding die for collective transfer used for forming, for example, a wafer lens.

According to a method for producing a wafer lens, the method comprises a fifth process to obtain a wafer lens which includes a plurality of lens elements formed on a front surface of a third substrate by filling a space between the first or the second molding die (that is, a sub or a sub-sub-master die) obtained by the method for producing a molding die above and the front surface of the third substrate with a third resin material, curing the third resin material, and releasing the first or the second molding die. In this case, a wafer lens provided with a plurality of lens elements on one side of the third substrate can be obtained through reproduction by using transfer of the first or the second molding die.

According to particular aspect or focus of the present invention, a method for producing a wafer lens comprises a sixth process to obtain a wafer lens which includes a plurality of optical lenses formed on a rear surface of the third substrate by filling a space between the first or the second molding die (that is, a sub or a sub-sub-master die) obtained by the method for producing a molding die above and the rear surface of the third substrate with a fourth resin material, curing the fourth resin material, and releasing the first or the second molding die. In this case, a wafer lens provided with a plurality of lens elements on both sides of the third substrate can be obtained through reproduction by using transfer of the first or the second molding die.

According to another aspect of the present invention, the sixth process is started before the first or the second molding die is released in the fifth process. Therefore, there is an effect that, for example, warpage of the wafer lens is reduced.

A method for producing an optical lens according to present invention comprises a process to divide by cutting the wafer lens obtained by the method for producing a wafer lens above. In this case, multiple high-performance optical lenses divided from the wafer lens can be obtained collectively.

### BRIEF DESCRIPTION OF DRAWINGS

FIG. 1 is a side view of a wafer lens (lens substrate) obtained by a molding method for a first embodiment, which includes partial enlarged perspective views of front and rear sides.

FIG. 2 is a side cross-sectional view of an optical lens obtained from the wafer lens of FIG. 1.

FIG. 3A is a perspective view illustrating a master die used for the production of the wafer lens and FIG. 3B is a perspective view of a sub-master substrate of a sub-master die which is to be produced by the master die.

FIG. 4A is a perspective view which explains a cut-out part of the master die, FIG. 4B is a perspective view which explains a cut-out part of a sub-master die, and FIG. 4C is a perspective view which explains a cut-out part of a sub-sub-master die.

FIG. 5 is a block diagram illustrating, in circuit, machining apparatus for producing, for example, a sub-master die 40.

FIG. 6 is a perspective view illustrating an exterior of the machining apparatus of FIG. 5.

FIG. 7 is a plan view illustrating the machining apparatus of FIG. 5.

FIG. 8 is a side cross-sectional view illustrating the machining apparatus of FIG. 5.

FIGS. 9A to 9E are diagrams for describing a production process of the wafer lens.

FIGS. 10A to 10D are diagrams for describing the production process of the wafer lens.

FIG. 11 is a flowchart which conceptually describes the production process of the wafer lens.

FIG. 12 is a flowchart which conceptually describes production process of the sub-master die.

FIG. 13 is a partially enlarged sectional view illustrating dimensional conditions at the time of production of the sub-master die.

### DESCRIPTION OF EMBODIMENTS

With reference to the drawings, a wafer lens finally obtained by using a method for producing a molding die according to one embodiment of the present invention will be described, and a structure and a method for producing a molding die for producing such a wafer lens will be described.

### [Structures of Wafer Lens and Other Components]

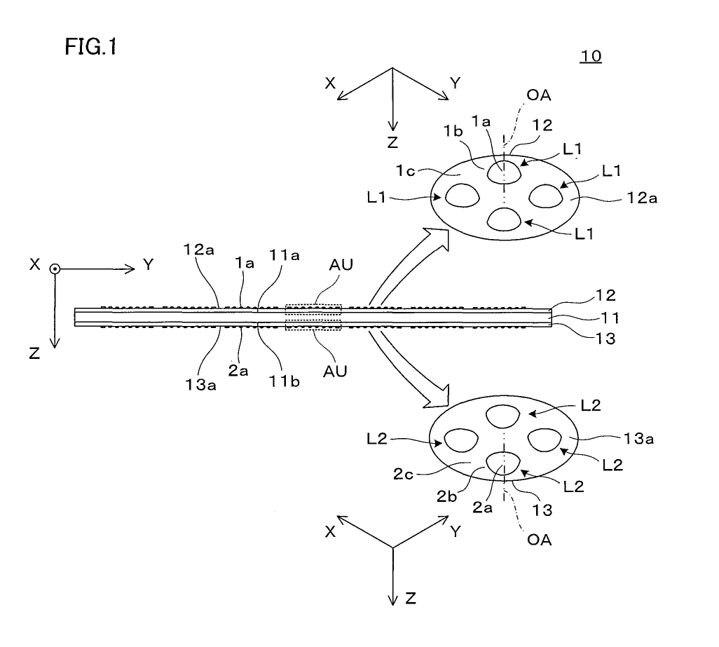

As illustrated in FIG. 1, a wafer lens 10 has a disc-like outer shape, and includes a substrate 11, a first lens resin layer 12 and a second lens resin layer 13. In the present embodiment, the wafer lens 10 may be referred also to as a lens substrate. Note that, in FIG. 1, surfaces of the first lens resin layer 12 and the second lens resin layer 13 are partially enlarged and illustrated as perspective views.

The substrate 11 of the wafer lens (lens substrate) 10 is a circular plate (later-described third substrate) embedded at the center of the wafer lens 10, and is made of light transmissive glass. An outer diameter of the substrate (third substrate) 11 is substantially the same as those of the first and the second lens resin layers 12 and 13. The thickness of the substrate 11 is basically determined in accordance with optical specifications. The thickness is determined such that the substrate 11 is not damaged at least when a molded product is released from a mold to obtain the wafer lens 10.

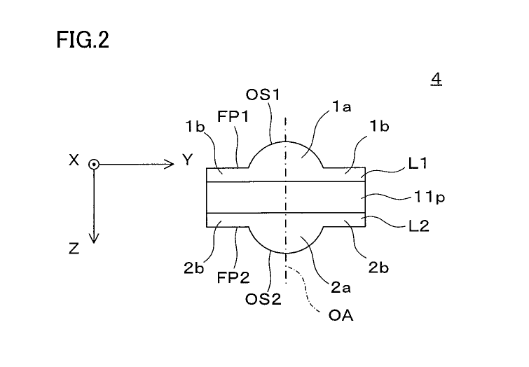

The first lens resin layer 12 is a light transmissive layer and is formed on one surface 11a of the substrate 11. As illustrated in the partially enlarged perspective view, in the first lens resin layer 12, multiple first lens elements L1 each constituted by a first lens body 1a and a first flange portion 1b as a set are arranged in two dimensions along with an XY plane. These first lens elements L1 are collectively molded via a connecting portion 1c. A surface on which each first lens element L1 and the connecting portion 1c are combined with each other is formed as a first receiving surface or transfer target surface 12a which is collectively formed by transferring. As illustrated also in FIG. 2, the first lens body 1a, for example, is a convex-shaped aspherical or spheric lens portion, and includes a first optical surface OS1. The surrounding first flange portion 1b includes a flat first flange surface FP1 which spreads around the first optical surface OS1, and an outer periphery of the first flange surface FP1 is formed also as a surface of the connecting portion 1c. The first flange surface FP1 is disposed in parallel with the XY plane which is vertical to an optical axis OA.

Note that, as illustrated in FIG. 1, the first lens resin layer 12 is divided into multiple array units AU due to its production process. Although not illustrated in detail, these array units AU have rectangular outlines and are arranged in a matrix pattern on the substrate 11. Each array unit AU has a surface shape which substantially corresponds to a reversed shape of an end surface 30a of a master die 30 which will be described later. Each array unit AU includes multiple first lens bodies la arranged at regular intervals in a matrix pattern.

The first lens resin layer 12 is made of, for example, light-curing resin. The light-curing resin is obtained by curing a light-curing resin material which includes polymerizable composition, such as a polymerizable monomer, which is a principal constituent, a photopolymerization initiator for starting polymerization curing of the polymerizable composition, and various additives used if necessary. Such a light-curing resin material has flowability in a state before curing. Examples of the light-curing resin include epoxy resin, acrylic resin, allyl ester resin and vinyl resin. Epoxy resin may be obtained by reaction curing of the polymerizable composition by cationic polymerization of photopolymerization initiator. Acrylic resin, allyl ester resin and vinyl resin may be obtained by reaction curing of the polymerizable composition by radical polymerization of the photopolymerization initiator.

Like the first lens resin layer 12, the second lens resin layer 13 is a light transmissive layer, and is formed on the other surface 11b of the substrate 11. As illustrated in the partially enlarged perspective view, in the second lens resin layer 13, multiple second lens elements L2 each constituted by a second lens body 2a and a second flange portion 2b as a set are arranged in two dimensions along with an XY plane. These second lens elements L2 are collectively molded via a connecting portion 2c. A surface on which each second lens element L2 and the connecting portion 2c are combined with each other is formed as a second receiving surface or transfer target surface 13a which is collectively formed by transferring. As illustrated also in FIG. 2, the second lens body 2a is, for example, a convex-shaped aspherical or spheric lens portion, and includes a second optical surface OS2. The surrounding second flange portion 2b includes a flat second flange surface FP2 which spreads around the second optical surface OS2, and an outer periphery of the second flange portion FP2 is formed also as a surface of the connecting portion 2c. The second flange surface FP2 is disposed in parallel with the XY plane which is vertical to an optical axis OA.

Note that the second lens resin layer 13 is also divided into multiple array units AU due to its production process. These array units AU have rectangular outlines and are arranged in a matrix pattern on the substrate 11.

The light-curing resin used for the second lens resin layer 13 is the same light-curing resin as that used for the first lens resin layer 12. However, it is not necessary that both the lens resin layers 12 and 13 are made of the same light-curing resin: these lens resin layers 12 and 13 may be made of different types of light-curing resin.

Note that any one of the first lens resin layer 12 and the second lens resin layer 13 may be omitted. That is, the lens resin layer may be provided only in one surface 11a or in the other surface 11b of the substrate 11.

As illustrated in FIG. 2, any one of the first lens elements L1 provided in the first lens resin layer 12, a second lens element L2 in the second lens resin layer 13 facing that first lens resin layer 12, and a portion 11p of the substrate 11 disposed between these lens elements L1 and L2 correspond to a single optical lens 4. The optical lens 4 is a compound lens which is square in shape when seen in a plan view obtained through division by dicing the wafer lens 10 at positions of the connecting portions 1c and 2c.

### [Structure of Molding Die for Transferring Shape]

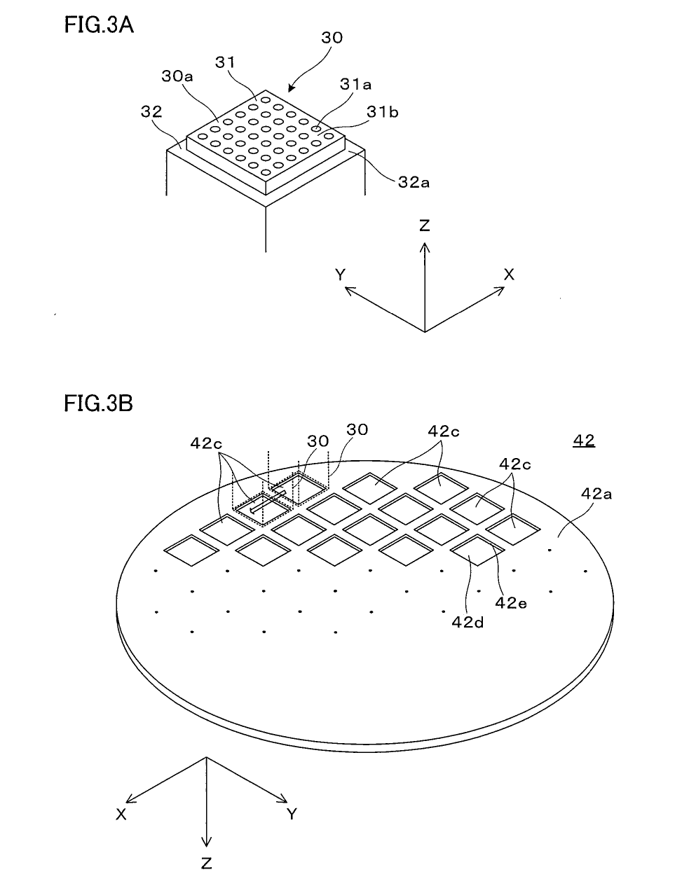

The wafer lens 10 of FIG. 1 is produced by performing three-stage transfer processes using a master die 30 illustrated in FIG. 3A as an original. Hereinafter, structures of the master die 30 and a molding die which includes a resin-made shape transfer surface obtained from the master die 30 will be described.

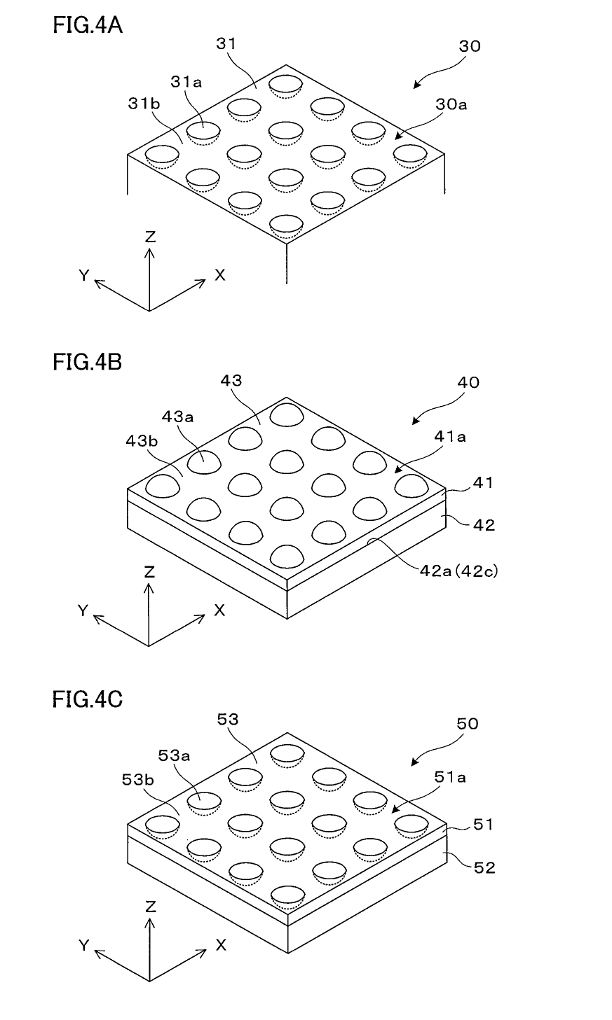

As illustrated in FIGS. 3A and 4A, the master die 30 is a block member having a rectangular parallelepiped shape. The master die 30 includes, on the end surface 30a thereof, a first molding surface 31 for forming a second molding surface 43 of a sub-master die 40 of FIG. 4B and an annular step 32 (for example, a rectangular frame portion) provided in the periphery of the first molding surface 31. The master die 30 is repeatedly used for producing a sub-master die 40. The master die 30 can be used to form a sub-master resin layer 41 on which units (later-described resin layer portions) which are arranged in an isolated manner on the sub-master substrate 42 are collected by transferring in a step-and-repeat system in which the master die 30 repeats transferring while moving in two dimensions so as to face shallow rectangular recessed portions 42c which are formed uniformly in a matrix pattern on the sub-master substrate 42. The first molding surface 31 of the master die 30 has a shape corresponding to a partially reversed shape of the first receiving surface or transfer target surface 12a of the first lens resin layer 12 of the wafer lens 10 to be obtained finally. The first molding surface 31 includes a first optical transfer surface 31a for forming the first optical surface OS1 in the first receiving surface 12a and a flat first flange transfer surface 31b for forming the first flange surface FP1 in the first receiving surface 12a. Multiple first optical transfer surfaces 31a are disposed, for example, on lattice points at equal intervals, and each of which is formed in a shape to correspond to a shape of a finally obtained optical lens: here, a substantially hemispherical concave shape. The step 32 includes a retreated surface 32a for forming a gap between the retreated surface 32a and a surface around a recessed portion 42c formed in the sub-master substrate 42 when the recessed portion 42c is filled with a resin material. The step 32 is a portion for forming a residual film portion which will be described in detail later in the sub-master resin layer 41 of the sub-master die 40. In order to improve releasability of the molded product, a side surface portion from the retreated surface 32a to the end surface 30a may be tapered, as it nears the end surface 30a, toward the center of the first molding surface 31.

Generally, the master die 30 is made of a metallic material. Examples of the metallic material may include an iron-based material, an iron-based alloy and non-iron-based alloy. Note that the master die 30 may be made of metallic glass or an amorphous alloy. The master die 30 is not limited to those made of a single material: the master die 30 may be formed by plating a suitable base with metallic materials described above.

As illustrated in a partially enlarged manner in FIG. 4B, the sub-master die 40 which is a first molding die includes a sub-master resin layer 41 and a sub-master substrate 42. In FIG. 4B, for the ease of understanding, a cut-out part of the sub-master die 40 is illustrated schematically. The sub-master resin layer 41 and the sub-master substrate 42 are in a stacked structure. The sub-master resin layer 41 is a shape transfer layer and includes, on an end surface 41a thereof, a second molding surface 43 for forming a third molding surface 53 of a sub-sub-master die 50 which will be described later. The second molding surface 43 corresponds to a positive type of the first receiving surface 12a of the first lens resin layer 12 of the finally obtained wafer lens 10. The second molding surface 43 includes a second optical transfer surface 43a for forming the first optical surface OS1 in the first receiving surface 12a and a second flange transfer surface 43b for forming the first flange surface FP1 in the first receiving surface 12a. Multiple second optical transfer surfaces 43a are transferred by the first optical transfer surface 31a and are disposed on lattice points. Each of the second optical transfer surfaces 43a is formed in a substantially hemispherical convex shape.

The sub-master resin layer 41 is made of a first resin material. Examples of the first resin material include a light-curing resin material: a light-curing resin material which becomes epoxy resin, acrylic resin, allyl ester resin, vinyl resin and the like after curing may be used as in the first lens resin layer 12 of the wafer lens 10. A desirable first resin material is a resin material which has favorable releasability after curing, especially a resin material which is sufficiently light transmissive in curing wavelengths and may be released from a mold without application of a mold release agent.

The sub-master substrate 42 is a first substrate made of a light transmissive and sufficiently rigid material. For example, the sub-master substrate 42 is made of glass. On the entire surface 42a of the sub-master substrate (first substrate) 42, as illustrated in FIG. 3B, multiple shallow rectangular-shaped recessed portions 42c are formed in a matrix pattern. Typically, each recessed portion 42c is a recess of which depth is equal to or smaller than 200 micrometers, which includes a bottom surface 42d and a side surface 42e, and which is closed inside it. The recessed portions 42c prevent the first resin material from becoming excessively thin when transfer is performed with the first resin material being disposed between the end surface 30a of the master die 30 and the surface 42a of the sub-master substrate 42. With this, it is possible to bring the master die 30 close to a suitable position to the surface 42a of the sub-master substrate 42 without pressing the master die 30 against the sub-master substrate 42 with large pressure. The recessed portions 42c may be formed by various methods, such as cutting and etching, to the sub-master substrate 42. A side surface 42e of the recessed portion 42c may be inclined or may be formed as a curved surface so that the area of the opening of the recessed portion 42c decreases as it nears the bottom surface 42d. In this manner, the recessed portion 42c may be formed comparatively easily. Alternatively, the side surface 42e may be inclined so that the area increases as it nears the bottom surface 42d or the side surface 42e may be roughened. In this manner, unsuccessful release at the time of releasing from the master die 30 may be reduced.

As illustrated in a partially enlarged manner in FIG. 4C, the sub-sub-master die 50 which is a second molding die include a sub-sub-master resin layer 51 and a sub-sub-master substrate 52. In FIG. 4C, for the ease of understanding, a cut-out part of the sub-sub-master die 50 is illustrated schematically. The sub-sub-master resin layer 51 and the sub-sub-master substrate 52 are in a stacked structure. The sub-sub-master resin layer 51 is a shape transfer layer and includes, on an end surface 51a thereof, a third molding surface 53 for forming the first lens resin layer 12 of the wafer lens 10 by transferring. The third molding surface 53 has a shape corresponding to a reversed shape of the first receiving surface 12a of the first lens resin layer 12 of the wafer lens 10. The third molding surface 53 includes a third optical transfer surface 53a for forming the first optical surface OS1 in the first receiving surface 12a and a third flange transfer surface 53b for forming a first flange surface FP1 in the first receiving surface 12a. As described above, a plurality of third optical transfer surfaces 53a are transferred by the second optical transfer surface 43a and are disposed in a matrix pattern. Each of the third optical transfer surfaces 53a is formed in a substantially hemispherical concave shape.

The sub-sub-master resin layer 51 is made of a second resin material which is the same as the first resin material of the sub-master resin layer 41. The sub-sub-master substrate 52 as the second substrate is made of a material which is the same as that of the sub-master substrate 42. That is, as a second resin material of the sub-sub-master resin layer 51, a light-curing resin material which becomes epoxy resin, acrylic resin, allyl ester resin, vinyl resin and the like after curing may be used. The sub-sub-master substrate (second substrate) 52 is made of a light transmissive and sufficiently rigid material. For example, the sub-sub-master substrate 52 is made of glass.

It is not necessary that the sub-master resin layer 41 and the sub-sub-master resin layer 51 are made of the same material: these layers may be made of different types of light-curing resin. Further, it is not necessary that the sub-master substrate 42 and the sub-sub-master substrate 52 are made of the same material: these substrates may be made of different materials.

Mold releasing layers may be formed through, for example, application of a mold release agent on the master die 30, the sub-master die 40 and the sub-sub-master die 50 to facilitate releasing of a molded product from the mold.

### [Machining Apparatus of Sub-Master Die and the Like]

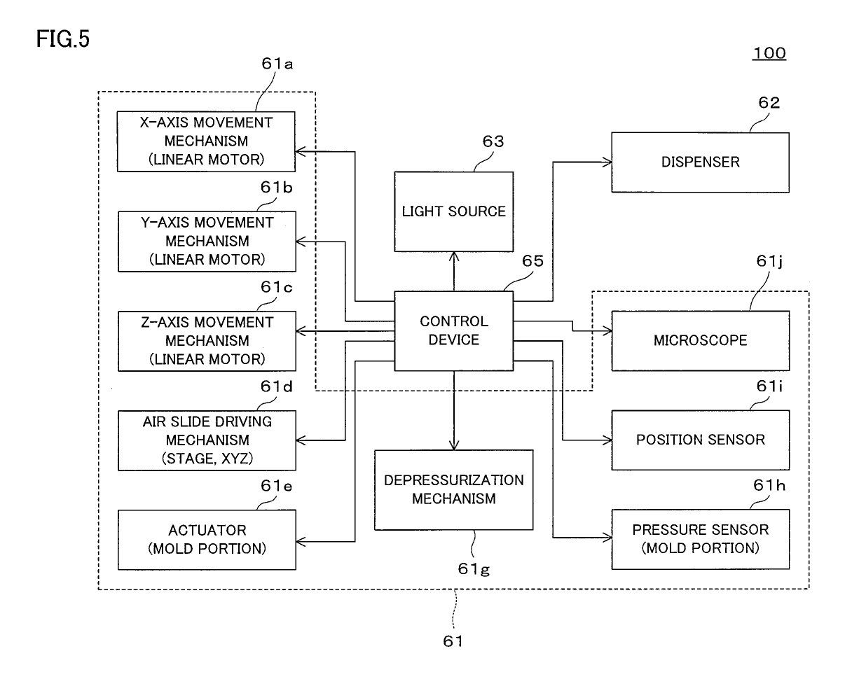

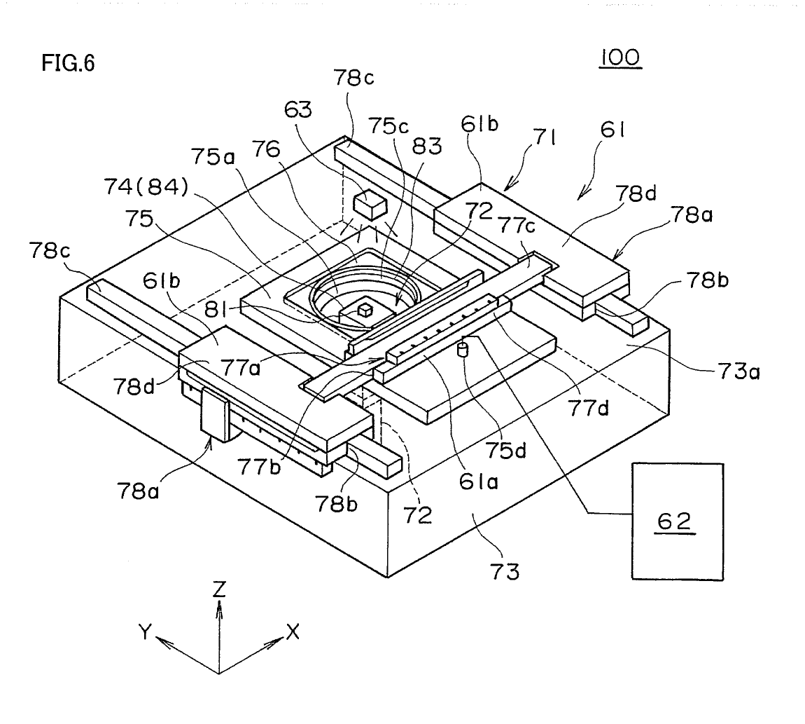

Hereinafter, machining apparatus for producing the sub-master die 40 and the like illustrated in FIG. 4B will be described with reference to FIGS. 5, 6 and other figures.

As illustrated in FIG. 5, machining apparatus 100 includes an alignment driving unit 61, a dispenser 62, a light source 63 and a control device 65. Here, the alignment driving unit 61 is for disposing, in a precisely aligned manner, the master die 30 illustrated in FIG. 3A with respect to each of the recessed portions 42c provided in the sub-master substrate 42 illustrated in FIG. 3B. The alignment driving unit 61 includes: an X-axis movement mechanism 61a for moving the sub-master substrate 42 to a desired position in an X-axis direction; a Y-axis movement mechanism 61b for moving the sub-master substrate 42 to a desired position in a y-axis direction; a Z-axis movement mechanism 61c for moving the master die 30 to a desired position in a Z-axis direction; an air slide driving mechanism 61d for enabling smooth movement of the movement mechanisms 61a, 61b, 61c and the like; an actuator 61e for adjusting inclination and rotational posture of the master die 30; a depressurization mechanism 61g for depressurizing a peripheral space of the master die 30 at suitable timing; a position sensor 61i for detecting the three-dimensional position or posture of the master die 30 with respect to the sub-master substrate 42; a microscope 61j for observing alignment conditions; and a pressure sensor 61h for detecting pushing pressure of the master die 30 against the sub-master substrate 42.

The dispenser 62 has a role to supply the first resin material consisting of a light-curing resin material onto the master die 30 in order to form the sub-master resin layer 41 on the sub-master substrate 42 illustrated in FIG. 3B. The light source 63 generates light of a wavelength for curing the resin material toward the first resin material disposed between the master die 30 and the sub-master substrate 42. The light source 63 is, for example, a UV light source. By the illumination emerged from the light source 63, the cured sub-master resin layer 41 is formed on the sub-master substrate 42.

The control device 65 is a portion which collectively controls drive of each part of the alignment driving unit 61, the dispenser 62, the light source 63 and the like.

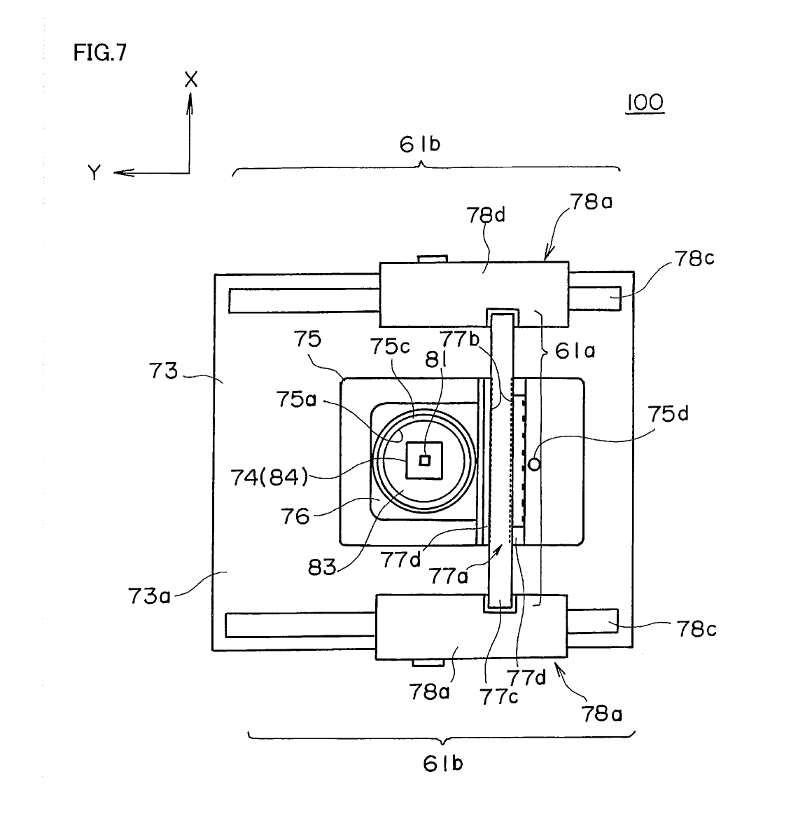

As illustrated in FIGS. 6 and 7, in the alignment driving unit 61 of the machining apparatus 100, an XY driving mechanism 71 is disposed on a surface plate 73 and a Z driving mechanism 72 is disposed to be embedded in the surface plate 73. Above the XY driving mechanism 71, the light source 63 is supported via a support portion (not illustrated) extending from the surface plate 73. A mold portion 74 is supported in an upper portion of the Z driving mechanism 72. The machining apparatus 100 may put a die member 81 which is placed in the mold portion 74, i.e., the master die 30, into a spatially desired arrangement state with respect to a substrate member 83 which is placed in the XY driving mechanism 71, i.e., the sub-master substrate 42.

The XY driving mechanism 71 includes: an XY stage 75 which is movable in two dimensions above the surface plate 73; an X-axis movement mechanism 61a which causes the XY stage 75 to move in the X-axis direction; and a pair of Y-axis movement mechanisms 61b and 61b which cause the XY stage 75 to move in the y-axis direction.

The XY stage 75 is disposed close to and so as to face an upper surface 73a of the surface plate 73. A through hole 75a which is circular in shape when seen in a plan view is formed in the XY stage 75 so as to penetrate the XY state 75 through upper and lower surfaces. A seat 75c which supports the substrate member 83 and a chuck (not illustrated) which fixes the seat 75c are provided in the periphery of the through hole 75a. On the XY stage 75, a lid portion 76 which is rectangular in shape when seen in a plan view is provided so as to cover the through hole 75a. The lid portion 76 is formed by a quartz plate or any other light transmissive plate member. Multiple exhaust ports or air-jet ports (not illustrated) through which air is exhausted are provided at a lower portion of the XY stage 75 as an air slide guide mechanism which accompanies the XY stage 75. The XY stage 75 is supported in a non-contact and relative displaceable manner by suitably driving the air slide driving mechanism 61d (see FIG. 5) and causing controlled air to be exhausted toward the upper surface 73a of the surface plate 73 through the exhaust ports. An opening 75d for introducing a needle portion for ejection (not illustrated) extending from the dispenser 62 (see FIG. 5) to the upper side of the mold portion 74 is formed at a position away from the through hole 75a of the XY stage 75.

The X-axis movement mechanism 61a includes a linear motor 77a which provides driving force to the XY stage 75 to move the same in the X-axis direction, and an air slide guide mechanism 77b which guides movement of the XY stage 75. Although not illustrated, the linear motor 77a is constituted by a stator, a moving element, a scale, a sensor and the like. The linear motor 77a may cause the XY stage 75 to be moved to a desired position in the X-axis direction along an X-axis guide 77c by the air slide driving mechanism 61d (see FIG. 5) which drives under the control of the control device 65. Although not illustrated, the air slide guide mechanism 77b includes multiple exhaust ports opening inside of an elongated protruding portion 77d extending from the XY stage 75, and guides the XY stage 75 with respect to the X-axis guide 77c in a non-contact and relatively displaceable manner.

The pair of Y-axis movement mechanisms 61b support the X-axis movement mechanism 61a via the X-axis guide 77c. Each Y-axis movement mechanism 61b includes: a linear motor 78a which provides driving force to the X-axis movement mechanism 61a to move the XY stage 75 in the y-axis direction; and an air slide guide mechanism 78b which guides movement of the X-axis movement mechanism 61a and the like supported by a movable body 78d which holds the linear motor 78a. Although not illustrated, the linear motor 78a is constituted by a stator, a moving element, a scale, a sensor and the like. The linear motor 78a may cause the X-axis movement mechanism 61a and the XY stage 75 to be moved to desired positions in the y-axis direction along a Y-axis guide 78c by the air slide driving mechanism 61d (see FIG. 5) which drives under the control of the control device 65. Although not illustrated, the air slide guide mechanism 78b includes multiple exhaust holes opening inside of a movable body 78d in which the linear motor 78a is incorporated, and supports the X-axis movement mechanism 61a and the like with respect to the Y-axis guide 78c in a non-contact and relatively displaceable manner.

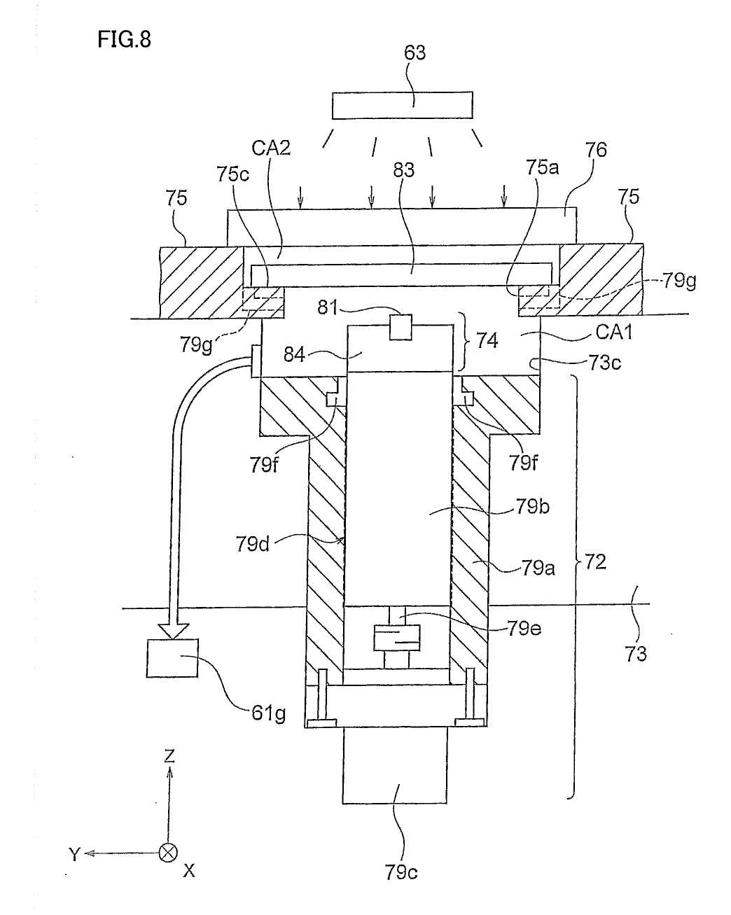

The Z driving mechanism 72 illustrated in FIG. 8 includes a Z-axis guide 79a, a Z stage 79b, a motor 79c and an air slide guide mechanism 79d. A shaft 79e extends from the motor 79c in an extendable and retractable manner. The Z stage 79b supported by the shaft 79e is guided by the Z-axis guide 79a to move up and down in the Z-axis direction. Although not illustrated, the air slide guide mechanism 79d includes multiple exhaust holes opening inside of the Z-axis guide 79a, and guides the Z stage 79b with respect to the Z-axis guide 79a in a non-contact and relatively displaceable manner by suitably driving the air slide driving mechanism 61d (see FIG. 5).

An annular sealing member 79f is provided above the Z-axis guide 79a. With the sealing member 79f, the inside of a process space CA1 in the periphery of the mold portion 74 may be depressurized. This process space CA1 is a space defined by an upper surface of the Z stage 79b, an upper surface of the Z-axis guide 79a, an inner surface of an opening 73c of the surface plate 73, an inner surface of the through hole 75a of the XY stage 75, the substrate member 83 and the like and communicates with an upper space CA2 via a vent 79g provided in the XY stage 75. The upper space CA2 is a space defined by the substrate member 83, the inner surface of the through hole 75a of the XY stage 75, the lid portion 76 and the like. Inside of the process space CA1 and, therefore, inside of the upper space CA2 are connected to the depressurization mechanism 61g which includes a vacuum pump or the like and are thus able to be depressured at any time.

Although detailed description will be omitted, the mold portion 74 provided at an upper end of the Z-axis guide 79a includes a posture adjustment mechanism 84 for adjusting rotational posture and inclination posture of the die member 81. By causing the posture adjustment mechanism 84 to drive suitably, the die member 81 placed in the mold portion 74 may be suitably rotated about the Z-axis and suitably inclined with respect to the Z-axis and, therefore, the posture regarding rotation and inclination of the master die 30 with respect to the sub-master substrate 42 may be adjusted accurately. The mold portion 74 is driven by the control device 65 and the actuator 61e (see FIG. 5).

### [Production Process of Wafer Lens]

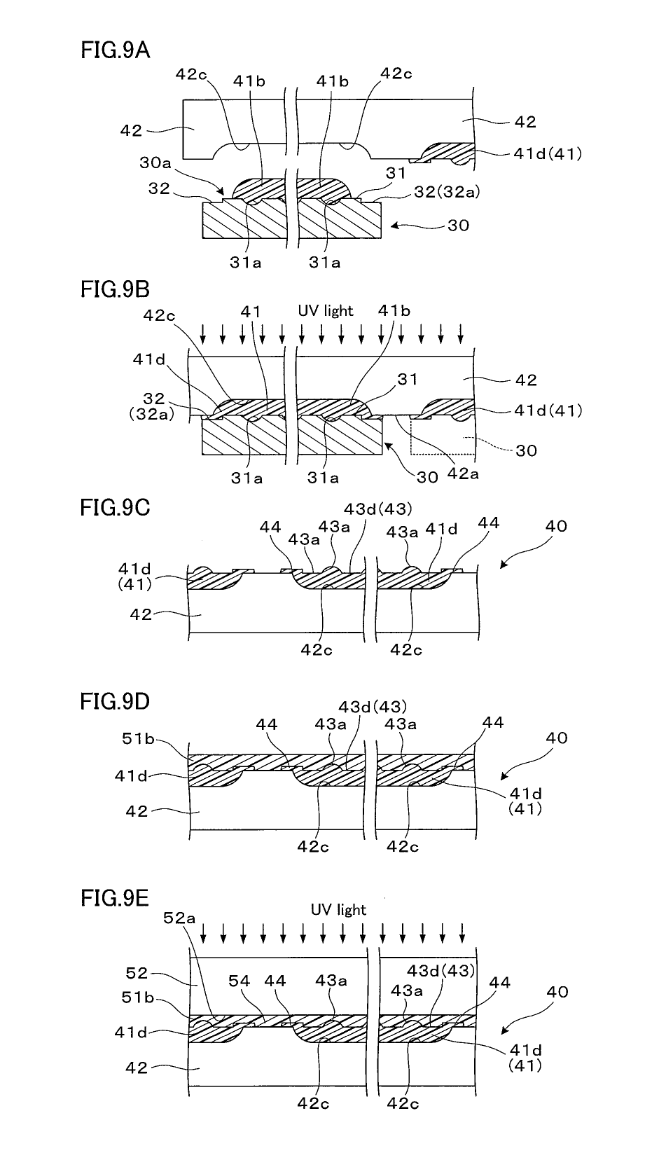

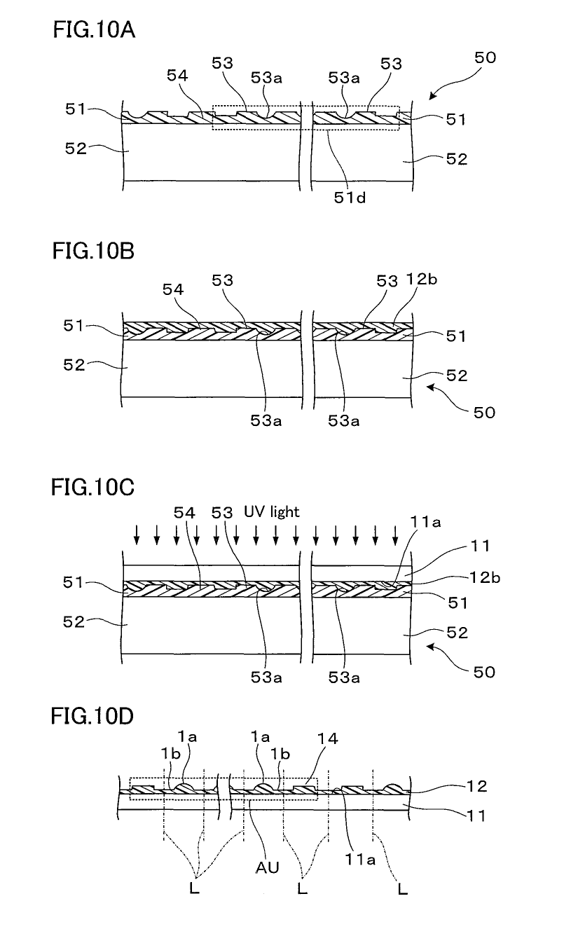

With reference to FIGS. 9A to 9E, 10A to 10D and other figures, an outline of a production process of the wafer lens 10 performed using the master die 30, the sub-master die 40 and the sub-sub-master die 50 described above will be described. Although molding of the first lens resin layer 12 will be described below, the same process will be performed for the molding of the second lens resin layer 13.

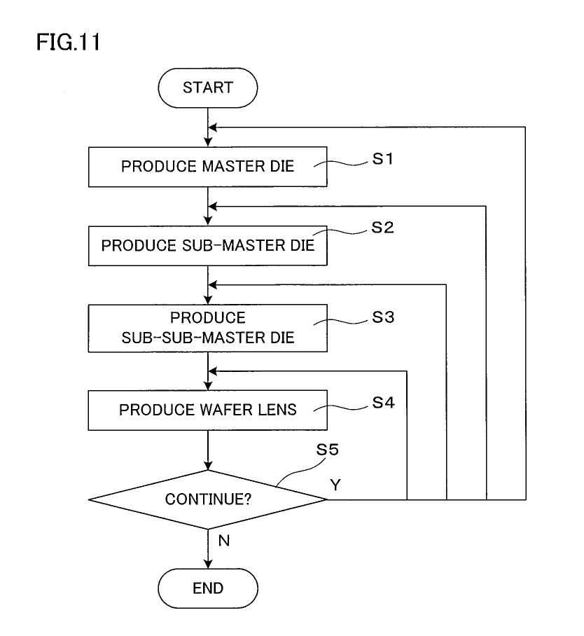

First, the master die 30 corresponding to a negative type of each array unit AU which constitutes the first lens resin layer 12 of the wafer lens 10 is produced by, for example, grinding (see step S1 of FIG. 11).

Next, as illustrated in FIG. 9A, the first resin material 41b is disposed on the first molding surface 31 of the master die 30 using the machining apparatus 100 illustrated in FIG. 5 and other figures. Then, as illustrated in FIG. 9B, the end surface 30a of the master die 30 is aligned and disposed to face a particular recessed portion 42c formed on the surface 42a of the sub-master substrate 42 using the machining apparatus 100 illustrated in FIG. 5 and other figures. The master die 30 is pressed from the lower direction of the sub-master substrate 42 so that the first molding surface 31 and the recessed portion 42c are brought close to a suitable distance. Here, the resin material 41b is pressed by the master die 30, and the recessed portion 42c and a facing portion (a gap portion) between the retreated surface 32a of the step 32 of the master die 30 and the sub-master substrate 42 are filled with the resin material 41b. In this state, light of predetermined wavelength, such as the UV light, is emitted from the light source 63 and the first resin material 41b disposed therebetween is cured. Therefore, the first molding surface 31 of the master die 30 is transferred to the first resin material 41b, and a resin layer portion 41d which includes a transfer surface element 43d divided from the second molding surface 43 is formed in the first resin material 41b. Next, as illustrated in FIG. 9C, the resin layer portion 41d and the sub-master substrate 42 are collectively released from the master die 30. In this manner, the resin layer portion 41d is exposed in a rectangular area which includes recessed portion 42c which the end surface 30a of the master die 30 faced. This resin layer portion 41d includes a residual film portion 44 in the periphery of a main body as a transferred product of the step 32 of the master die 30. The resin layer portion 41d includes, as a surface thereof, the transfer surface element 43d which constitutes a part of the second molding surface 43. If n first optical transfer surfaces 31a are formed on the first molding surface 31 of the master die 30, the transfer surface element 43d includes n second optical transfer surfaces 43a corresponding thereto.

Next, returning to FIG. 9A, the first resin material 41b is disposed on the first molding surface 31 of the master die 30. Then, as illustrated in FIG. 9B, the end surface 30a of the master die 30 is aligned and disposed to face a subsequent recessed portion 42c formed on the surface 42a of the sub-master substrate 42. The master die 30 is pressed from the lower direction of the sub-master substrate 42 so that the first molding surface 31 and the recessed portion 42c are brought close to a suitable distance. Here, the resin material 41b is pressed by the master die 30, and the recessed portion 42c and a facing portion (a gap portion) between the retreated surface 32a of the step 32 of the master die 30 and the sub-master substrate 42 are filled with the resin material 41b. In this state, light of predetermined wavelength, such as the UV light, is emitted from the light source 63 and the first resin material 41b disposed therebetween is cured. Therefore, the first molding surface 31 of the master die 30 is transferred to the first resin material 41b, and a resin layer portion 41d which includes a transfer surface element 43d divided from the second molding surface 43 is formed in the first resin material 41b. This resin layer portion 41d includes a residual film portion 44 in the periphery of a main body as a transferred product of the step 32 of the master die 30. By the facing portion between the retreated surface 32a of the step 32 of the master die 30 and the sub-master substrate 42 being filled with the resin material 41b, since excessive resin material 41b is received in the facing portion even if the molding surface of the master die 30 is brought sufficiently close to the recessed portion 42c of the sub-master substrate 42, occurrence of unintended abnormal shapes due to overflowed resin from the master die 30 may be prevented. Shortage of the resin material 41b which is to be poured in the recessed portion 42c can be prevented. Therefore, if the resin material runs short, occurrence of abnormal shapes, during the next process of molding the sub-sub-master die, such as projection, caused by this shortage of the resin material can be prevented. Such abnormal shapes may cause excessively large height difference of the sub-sub-master resin layer 51 at the time of molding the sub-sub-master die 50. With the abnormal shapes, there is also a possibility that the thickness of the first lens resin layer 12 of the wafer lens 10 becomes excessively large, or that the accuracy in thickness of the first lens resin layer 12 of the wafer lens 10 is reduced. Formation of unintended abnormal shape may cause unsuccessful mold release.

By repeating the above process, the resin layer portion 41d is formed in all the recessed portions 42c formed on the sub-master substrate 42 and the sub-master resin layer 41 including multiple resin layer portions 41d arranged in a matrix pattern is formed. In this manner, the sub-master die 40 is completed (see step S2 of FIG. 11). If m recessed portions 42c have been formed on the sub-master substrate 42, the sub-master resin layer 41 includes m resin layer portions 41d corresponding thereto. That is, n×m second optical transfer surfaces 43a have been formed on the sub-master die 40.

Next, as illustrated in FIG. 9D, the second resin material 51b is disposed in a broad area on the second molding surface 43 of the sub-master die 40 using machining apparatus which is the same as the machining apparatus 100 illustrated in FIG. 5 and other figures. Then, as illustrated in FIG. 9E, using machining apparatus which is the same as the machining apparatus 100 illustrated in FIG. 5 and other figures, the sub-master die 40 is pressed from the lower direction of the sub-sub-master substrate 52 so that the second molding surface 43 and a surface 52a of the sub-sub-master substrate 52 are moved close to a suitable distance. In this state, light of predetermined wavelength, such as the UV light, is emitted from the light source and the second resin material 51b disposed therebetween is cured. Therefore, the sub-sub-master resin layer 51 to which the second molding surface 43 of the sub-master die 40 is transferred and which is constituted by cured resin is formed. That is, the third molding surface 53 (the third optical transfer surface 53a and the third flange transfer surface 53b illustrated in FIG. 4C are included) is formed on the sub-sub-master resin layer 51. Although the light is illuminated from the side of the sub-sub-master substrate 52 in the present embodiment, the light may be illuminated from the side of the sub-master die 40 or both from the side of the sub-sub-master substrate 52 and from the side of the sub-master die.

Next, as illustrated in FIG. 10A, the sub-sub-master resin layer 51 and the sub-sub-master substrate 52 are collectively released from the sub-master die 40, and thus the independent sub-sub-master die 50 is completed (see step S3 of FIG. 11). The sub-sub-master resin layer 51 of the sub-sub-master die 50 is divided into multiple resin layer portions 51d corresponding to the resin layer portions 41d of the sub-master die 40, and these resin layer portions 51d are arranged in a matrix pattern. A projecting portion 54 of which shape corresponds to the shape of the recessed portion located between the residual film portions 44 of the sub-master die 40 is formed in the outside of each resin layer portion 51d. The projecting portion 54 extends in the shape of a lattice pattern on the surface of the sub-sub-master die 50.

Next, production of the wafer lens 10 is started. As illustrated in FIG. 10B, a third resin material 12b (a light-curing resin material for forming the first lens resin layer 12) is disposed in a broad area on the third molding surface 53 of the sub-sub-master die 50 using machining apparatus which is the same as the machining apparatus 100 illustrated in FIG. 5 and other figures. Then, as illustrated in FIG. 10C, using machining apparatus which is the same as the machining apparatus 100 illustrated in FIG. 5 and other figures, the sub-sub-master die 50 is pressed from the lower direction of the substrate 11 so that the third molding surface 53 and a surface (one surface) 11a of the substrate 11 are moved close to a suitable distance. In this state, light of predetermined wavelength, such as the UV light, is emitted from the light source and the third resin material 12b disposed therebetween is cured. Therefore, the first lens resin layer 12 to which the third molding surface 53 of the sub-sub-master die 50 is transferred and which is constituted by the cured resin is formed. That is, the first receiving surface 12a (the first optical surface OS1 and the first flange surface FP1 illustrated in FIG. 1 are included) is formed on the first lens resin layer 12. Although the light is illuminated from the side of the substrate 11 in the present embodiment, the light may be illuminated from the side of the sub-sub-master substrate 52 or both from the side of the substrate 11 and from the side of the sub-sub-master substrate 52.

Then, as illustrated in FIG. 10D, the first lens resin layer 12 and the substrate 11 are collectively released from the sub-sub-master die 50. If the second lens resin layer 13 has already been formed, the wafer lens 10 is completed (see step S4 of FIG. 11). If the second lens resin layer 13 has not been formed, the second lens resin layer 13 made of a fourth resin material is formed by performing the same process as that in the first lens resin layer 12 and, the wafer lens 10 is completed by collectively releasing the second lens resin layer 13 and the substrate 11 from the sub-sub-master die 50 for the second lens resin layer 13 (see step S4 of FIG. 11). Note that the process for forming the second lens resin layer 13 may be started before the sub-sub-master die 50 is released from the die to obtain the first lens resin layer 12. By starting the molding on the other surface of the substrate 11 in a state in which the molding die is left on one surface of the substrate 11, occurrence of warpage in the molded produce is reduced easily.

The first lens resin layer 12 of the wafer lens 10 is divided into multiple array units AU arranged in a matrix pattern corresponding to the resin layer portions 51d of the sub-sub-master die 50. A projection 14 is formed at an outer edge of each array unit AU to correspond to a recess adjoining to the projecting portion 54 formed in the sub-sub-master resin layer 51 of the sub-sub-master die 50, i.e., the residual film portion 44 of the sub-master die 40.

A plurality of types of wafer lenses 10 are produced in, for example, the same process as that described above and are stacked suitably, and then, cut along dicing lines L into square prism-like shape by dicing with the first lens body 1a and the like being the center. In this manner, a plurality of divided compound lenses, i.e., the optical lenses 4 (see FIG. 2), are completed.

The master die 30, the sub-master die 40 and the sub-sub-master die 50 described above are used a plurality of times (see step S5 of FIG. 11). That is, when these models 30, 40 and 50 deteriorated and need to be replaced or changed, steps S1 to S4 of FIG. 11 are performed to the suitable upper limit times while replacing any of the master die 30, the sub-master die 40 and the sub-sub-master die 50 with new one or another one reused. Therefore, for example, i×j×k wafer lenses 10 may be obtained while the master die 30 being transferred i times, the sub-master die 40 being transferred j times and the sub-sub-master die 50 being transferred k times.

### [Production Process of Sub-Master Die]

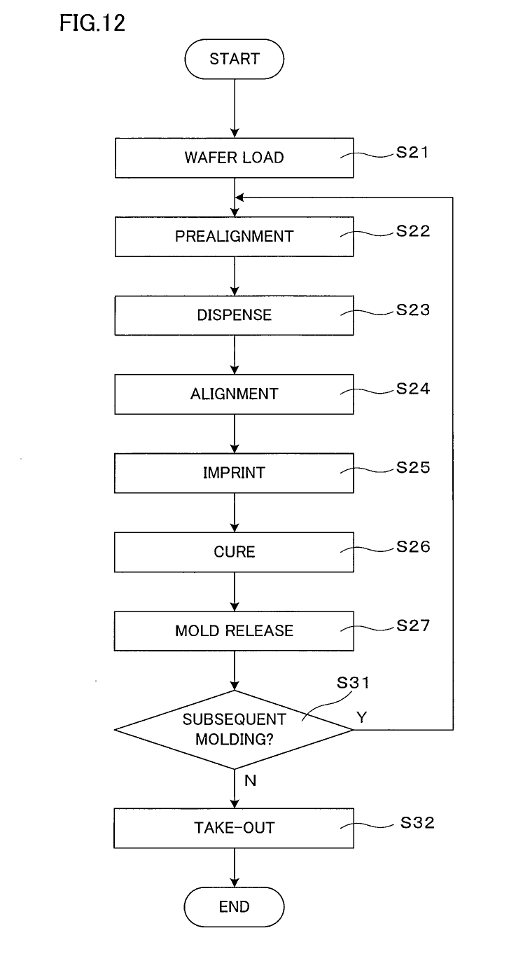

Hereinafter, with reference to FIG. 12, details of a method for producing the sub-master die 40 using the machining apparatus 100 illustrated in FIGS. 5, 6 and other figures will be described. First, the sub-master substrate 42 (the substrate member 83) is placed in the XY stage 75 (a wafer load process: see step S21 of FIGS. 12) and the through hole 75a of the XY stage 75 is covered by the lid portion 76.

Then, the X-axis movement mechanism 61a, the Y-axis movement mechanism 61b and the like are controlled so that the XY stage 75 is slid by the air in the X-axis direction and in the y-axis direction and alignment is performed so that a needle portion (not illustrated) of the dispenser 62 introduced from the opening 75d is positioned above the master die 30 (a prealignment process: see step S22 of FIG. 12). In this case, alignment marks are provided at the mold portion 74 and at the XY stage 75. In the prealignment process, alignment of the needle portion for ejection of the dispenser 62 is performed using the microscope 61j while checking the alignment marks described above.

Next, a predetermined amount of resin is ejected from an end of the needle portion for ejection of the dispenser 62 on the master die 30 (the die member 81) which is fixed to the upper portion of the mold portion 74 (a dispensing process: see step S23 of FIG. 12).

Then, the X-axis movement mechanism 61a, the Y-axis movement mechanism 61b, the posture adjustment mechanism 84 and the like are controlled so that the XY stage 75 is slid by the air in the X-axis direction and in the y-axis direction and alignment is performed so that the previously placed sub-master substrate 42 is suitably positioned above the master die 30 of the mold portion 74 (an alignment process: see step S24 of FIG. 12). This alignment process (step S24) corresponds to FIG. 9A.

At this time, the XY stage 75 is precisely disposed at a reference position using an unillustrated laser length measuring machine and the like which is provided in the position sensor 61i. The inclination of the upper surface of the master die 30 and the height position of the master die 30 are calculated by the position sensor 61i and, on the basis of the calculation result, the posture adjustment mechanism 84 is drove to precisely adjust the inclination and the height of the master die 30 with respect to the sub-master substrate 42. Therefore, the first molding surface 31 of the master die 30 faces the recessed portion 42c of the sub-master substrate 42 and a bottom surface of the recessed portion 42c and the first flange transfer surface 31b of the first molding surface 31 becomes parallel to each other. Further, the position sensor 61i detects a plurality of alignment marks formed in the upper surface of the master die 30. Therefore, the position of the master die 30 is precisely adjusted with respect to the sub-master substrate 42 together with the rotation angle.

With the master die 30 being thus aligned, the Z stage 79b is elevated by the Z driving mechanism 72 so that the master die 30 is brought close to a predetermined position with respect to the sub-master substrate 42, and the master die 30 is retained at that position (an imprint process: see step S25 of FIG. 12). Therefore, the first resin material 41b on the master die 30 is nipped between the master die 30 and the sub-master substrate 42 and spreads gradually, whereby the recessed portion 42c is filled with the first resin material 41b. At this time, the pushing pressure of the master die 30 against the sub-master substrate 42 is adjusted by monitoring the output of the pressure sensor 61h.

In the above-described imprint process (step S25), inside of the process space CA1 between the master die 30 and the sub-master substrate 42 is depressurized by the depressurization mechanism 61g and thereby entrainment of air bubbles into the first resin material 41b can be prevented.

Then, while retaining the position of the Z stage 79b, the light source 63 is drove to illuminate light of predetermined wavelength, such as the UV light, for a predetermined period of time to the first resin material 41b, whereby the first resin material 41b is cured and the resin layer portion 41d is obtained (a curing process: see step S26 of FIG. 12). At this time, inside of the process space CA1 is kept in a depressurized condition by the depressurization mechanism 61g. Therefore, oxygen inhibition to the first resin material 41b can be prevented and the first resin material 41b can be reliably cured.

Then, the Z stage 79b is lowered by the Z driving mechanism 72 and the cured resin layer portion 41d is released from the master die 30 together with the sub-master substrate 42 (a releasing process: see step S27 of FIG. 12). Also at this time, mold release of the resin layer portion 41d becomes easy by driving the depressurization mechanism 61g to put the inside of the process space CA1 into the depressurized condition.

Thereafter, by repeating the prealignment process (step S22), the dispensing process (step S23), the alignment process (step S24), the imprint process (step S25), the curing process (step S26) and the releasing process (step S27) necessary times, the resin layer portion 41d is sequentially formed on the sub-master substrate 42 to correspond to each recessed portion 42c.

If predetermined resin layer portions 41d have been formed on the sub-master substrate 42 (step S31 of FIG. 12: NO), it is determined that the sub-master die 40 has been completed. In this case, the XY stage 75 is returned to the reference position, the lid portion 76 is removed from the XY stage 75 and the sub-master die 40 is taken out (a take-out process: see step S32 of FIG. 12).

### [Dimensional Conditions at the Time of Forming Sub-Master Die]

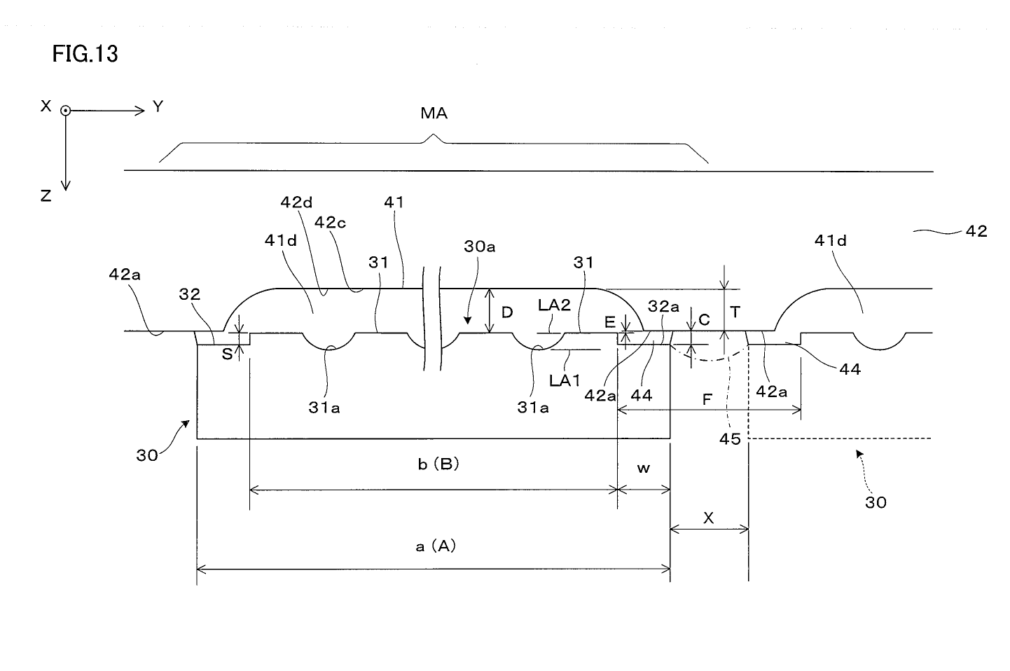

With reference to FIG. 13, conditions regarding the shape and position of the master die 30 at the time of molding the sub-master die 40 will be described.

Let the area of the master die 30 on the side of the end surface 30a be denoted by A and an effective area of the master die 30 be denoted by B. Here, the area A includes, not only the area of the first molding surface 31 of the master die 30, but the area of the retreated surface 32a of the step 32. On the other hand, the effective area B means only the area of the first molding surface 31 of the master die 30. Let an average distance from the bottom surface 42d of the recessed portion 42c to the first molding surface 31 at the time of curing (the distance to a virtual planar position obtained by averaging the first optical transfer surface 31a and the first flange transfer surface 31b so that the volume of a space formed between the recessed portion 42c becomes equivalent), i.e., the standard thickness of the resin layer portion 41d be denoted by D. Let the thickness of the residual film portion 44 of the outer periphery of the resin layer portion 41d be denoted by C. The standard thickness D of the resin layer portion 41d and the thickness C of the residual film portion 44 depend on how the master die 30 is brought close to the sub-master substrate 42 when the resin layer portion 41d of the sub-master die 40 is formed. That is, let the distance between the highest line LA2 in the first molding surface 31 of the master die 30 and the surface 42a of the sub-master substrate 42 be denoted by E and let the depth of the recessed portion 42c provided in the sub-master die 40 (counterbore depth) be denoted by T, the effective structure thickness D which is the standard thickness of the resin layer portion 41d is given by T+E. The thickness C of the residual film portion 44 is given by S+E when the step quantity of the step 32 of the master die 30 is denoted by S.

The residual film portion 44 is a portion obtained as a result that the master die 30 and the sub-master substrate 42 press the resin material and, thereby, the facing portion between the retreated surface 32a of the step 32 of the master die 30 and the sub-master substrate 42 is filled with the resin material 41b. Since the resin material 41b is molded without causing shortage of resin to the recessed portion 42c of the sub-master substrate 42 or producing unintended abnormal shapes due to overflowed resin material 41b from the master die 30, the residual film portion 44 is spread and formed in a predetermined width and to a predetermined thickness along the surface of the sub-master substrate 42. Since formation of the residual film portion 44 increases the area of the resin layer closely adhering to the sub-master substrate 42, the residual film portion 44 helps prevent occurrence of unsuccessful mold release during mold release of the master die 30. It is necessary that the volume of the residual film portion 44 occupies a certain or higher ratio of the volume of the entire resin layer portion 41d. In particular, the volume of the residual film portion 44 is about 2% or higher with respect to the volume of the resin layer portion 41d by securing a certain amount of the step quantity S of the step 32 of the master die 30 and the width w of the step 32 of the master die 30. If the volume of the residual film portion 44 is smaller than 2% of the volume of the entire resin layer portion 41d, a possibility that the residual film portion 44 is not filled with resin or that the resin overflows to the outside of the residual film portion 44 increases and there is a possibility that unintended abnormal shape (for example, the projection 45) may be formed in the periphery of the resin layer portion 41d. Such abnormal shapes may cause excessively large height difference of the sub-sub-master resin layer 51 at the time of molding the sub-sub-master die 50. With the abnormal shapes, there is a possibility that the thickness of the first lens resin layer 12 of the wafer lens 10 becomes excessively large, or that the accuracy in thickness of the first lens resin layer 12 of the wafer lens 10 is reduced. Formation of unintended abnormal shape may cause unsuccessful mold release.

On the other hand, if the residual film portion 44 is thin, it becomes necessary to increase the width w of the step 32. In this case, however, there is a problem that the occupation area of the resin layer portion 41d increases more than necessary by the residual film portion 44 and that the number of resin layer portions 41d which can be formed on the sub-master substrate 42 is reduced. If the thickness of the residual film portion 44 is reduced with the width w of the step 32 being narrowed, the volume ratio of the resin layer portion 41d is decreased. Therefore, for example, the first resin material 41b may overflow to the outside from the space defined between the retreated surface 32a of the master die 30 and the surface 42a of the sub-master substrate 42, thereby forming the unintended projection 45 in the periphery of the resin layer portion 41d. As described above, such a projection 45 may lead to difficult control of the thickness of the first lens resin layer 12 of the wafer lens 10 or occurrence of unsuccessful mold release. From the viewpoint described above, it is desirable to set the gap between the retreated surface 32a of the master die 30 and the surface 42a of the sub-master substrate 42, i.e., the thickness C of the residual film portion 44 to be equal to or greater than a certain value; for example, the thickness C of the residual film portion 44 is set to equal to or greater than 10 micrometers.

Regarding the residual film portion 44, from the viewpoint of reducing the thickness of the first lens resin layer 12 of the wafer lens 10, it is desirable that the projected height of the residual film portion 44 does not exceed the projected height of the main body portion of the resin layer portion 41d. Therefore, it is desirable that the retreated surface 32a of the master die 30 is situated further toward a tip end side near the sub-master substrate 42 than the lowest line LA1 in the first molding surface 31 (the furthest position in the Z direction from the sub-master substrate 42). According to the study of the present inventor, it has been confirmed that it is possible to design to receive the excessive resin material even if the thickness of the residual film portion 44 is reduced to the above-described value. Therefore, since it is not necessary to make the residual film portion 44 so thick, the thickness of the resin layer including the thickness of the residual film portion 44 itself can be reduced and, therefore, the thickness of the resin layer of the finally obtained wafer lens 10 can be reduced.

There is no particular lower limit about the distance E between the highest line LA2 in the first molding surface 31 of the master die 30 (the position nearest to the sub-master substrate 42 in the Z direction) and the surface 42a of the sub-master substrate 42 and the distance E may be a negative value (a state in which the first molding surface 31 enters the recessed portion 42c). However, the distance E depends on the position of the master die 30 at the time of molding, and is adjusted so that the thickness C of the residual film portion 44 is not smaller than the lower limit thereof: 10 micrometers. On the other hand, the upper limit of the distance E is set to be equal to or shorter than 100 micrometers in consideration of the meaning of providing the recessed portion 42c in the sub-master substrate 42. In an example, the vertical position of the highest line LA2 of the first molding surface 31 along the Z-axis direction substantially coincides with the vertical position of the surface 42a of the sub-master substrate 42 and the distance E is substantially close to zero.

It is necessary that the depth T of the recessed portion 42c in the sub-master substrate 42 is set to be equal to or greater than a certain value from the viewpoint of preventing reduction of the thickness of the first resin material 41b and controlling the spreading of the first resin material 41b; for example, the depth T is set to be equal to or greater than 10 micrometers. The depth T has a constant upper limit to cause the residual film portion 44 to function effectively. As described above, the volume of the residual film portion 44 is set to be about 2% or higher with respect to the volume of the resin layer portion 41d which is calculated on the basis of the depth T.

Hereinafter, the die distance X of the master die 30 before and after the movement at the time of molding a pair of adjoining resin layer portions 41d on the sub-master substrate 42 will be considered. The shorter the die distance X, the more desirable in that the number of resin layer portions 41d which can be formed on the sub-master substrate 42 can be increased and, therefore, the number of optical lenses 4 taken out of the wafer lens 10 can be increased. On the other hand, if the die distance X is shortened, a possibility that the unintended projection 45 is formed in the periphery of the resin layer portion 41d is increased as described above. Therefore, the maximum area MA that a single resin layer portion 41d can occupy in the sub-master substrate 42 will be considered first. The area SA of the maximum area MA is given by

SA=(X+a)²=(X+√A)²

on the basis of the y-axis direction width a of the master die 30. Therefore, an area in which the residual film portion 44 can be formed (hereafter, referred to as “non-effective area NA”) is given by

NA=SA−B=(X+√A)²−B

and the maximum volume allowed for the residual film portion 44 (hereafter, referred to as “buffer term TB”) is given by

TB=NA×C=[(X+√A)²−B]×C.

Here, the volume RV of the first resin material 41b for forming a single resin layer portion 41d is given by

RV=B×D+(A−B)×C.

Therefore, an error in supply volume of the first resin material 41b (hereafter, referred to as “resin variation term TD1”) is, for example, equal to or smaller than about the value given by

TD1=0.05×[B×D+(A−B)×C].

An error regarding the depth of the recessed portion 42c of the sub-master substrate 42 (hereafter, referred to as “depth variation term TD2”) is, for example, equal to or smaller than about the value given by

TD2=0.005×A.

Therefore, the buffer term TB should be set to about volume with which the resin variation term TD1 and the depth variation term TD2 can be absorbed, and the following relational expressions hold:

TB≧TD1+TD2 (1)

[(X+√A)²−B]×C≧0.05×[B×D+(A−B)×C]+0.005×A (2)

When the relational expression (2) is rearranged regarding the die distance X, the following relational expression holds:

X≧√{B+(0.05×[B×D+[A−B]×C]+0.005×A)/C}−√A (3).

Hereinafter, an example will be described. The area A of the end surface 30a of the master die 30 is, for example, 396 mm² (=19.9 mm×19.9 mm) and the effective area B of the master die 30 is, for example, 334.9=² (=18.3 mm×18.3 mm). The thickness C of the residual film portion 44 is, for example, about 0.04 mm and the effective structure thickness D of the resin layer portion 41d is, for example, about 0.1 mm. Therefore, the following inequality holds:

X≧0.83 mm.

That is, it is sufficient that the die distance X of the master die 30 before and after the movement is 0.83 mm. Since it is not desirable to unnecessarily increase the die distance X, the die distance X is set to about 0.85 mm.

According to the method for producing of the present embodiment, since a space between one of the plurality of recessed portions 42c formed in the sub-master substrate (the first substrate) 42 and the first molding surface 31 of the master die 30 is filled with the first resin material 41b, the thickness of the first resin material 41b which faces the first molding surface 31 is secured and, therefore, the master die 30 can be brought close to the sub-master substrate 42 relatively easily. In addition, by providing the annular step 32 in the periphery of the first molding surface 31 and by filling the space between the step 32 and the periphery of the recessed portion 42c with the first resin material 41b, shortage of the resin material with which the recessed portion 42c of the sub-master substrate 42 is filled or an overflow of excessive resin material from the master die 30 can be prevented and, thereby, occurrence of abnormal shapes can be prevented.

Note that the present invention is not limited to the above-described embodiment and can be suitably modified in a range without departing from the spirit and scope thereof.

For example, the contour shape of the wafer lens 10, the shape and arrangement of the lens elements L1 and L2 are not limited to those illustrated and various shapes may be selected in accordance with the use thereof.

Similarly, the shape of the sub-master resin layer 41 formed in the sub-master die 40, the shape of the sub-sub-master resin layer 51 formed in the sub-sub-master die 50 and the like are not limited to those illustrated and various shapes may be selected in accordance with the use thereof.

Although the resin layers 12, 13, 41 and 51 are made of light-curing resin and the resin materials are cured by light irradiation in the above description, the curing maybe accelerated by heating in addition to light irradiation. Alternatively, instead of the light-curing resin, the resin layers may be made of other energy-curing resin, such as thermosetting resin.

Although there is no particular limitation in the method for moving the master die 30 with respect to the sub-master substrate 42, it is desirable to employ a path to move to an adjoining recessed portion 42c if possible from the viewpoint of the processing speed. The sub-master substrate 42 may be moved with respect to the master die 30, or both of them may be moved. The same principle applies at the time of pressing the resin by the master die 30 and the sub-master substrate 42: instead of pressing the master die 30 against the sub-master substrate 42, the sub-master substrate 42 may be pressed against the master die 30, of both of them may be moved close to each other.

Although a lens which is provided with, on the substrate, the resin layer which functions as the optical lens has been described as the finally obtained wafer lens in the above-described embodiment, the wafer lens is not limited to the same: a wafer lens which includes no substrate and may be configured, by resin, integrally by a portion which functions as an optical lens, a flat portion in the periphery of the optical lens, and a portion which connects the optical lens and the flat portion.

Although an example in which the wafer lens is produced using the sub-sub-master die has been described in the above-described embodiment, the production of the wafer lens is not limited to the same: the wafer lens may be produced using the sub-master die. In this case, the master die used as an original is a positive type of the lens element of the wafer lens which is the final molded product. Both the first lens resin layer 12 and the second lens resin layer 13 may be molded using the sub-sub-master die, both of them may be molded using the sub-master die, or one of them is molded using the sub-sub-master die and the other is molded using the sub-master die.

1. A method for producing a molding die comprising:
a first process in which a master die including a molding surface on which multiple shapes corresponding to shapes of optical lenses are arranged and including an annular step in the periphery of the molding surface is arranged to be opposite to a first substrate for molding die including, on a flat surface thereof, a plurality of recessed portions which are greater in size than the molding surface and are closed inside thereof, so that the entire molding surface faces a single recessed portion among the plurality of recessed portions;
a second process in which the master die and the first substrate are brought relatively close to each other and in which a space between the molding surface and the first substrate is filled with a first resin material so that the recessed portion and the step are covered;
a third process in which the first resin material between the molding surface and the first substrate is cured; and
a fourth process in which the master die is released,
wherein a molding die including a resin-made shape transfer layer is obtained by moving the master die toward another recessed portion among the plurality of recessed portions and performing the first to fourth processes repeatedly.

2. The method for producing a molding die according to claim 1 wherein: a plurality of rectangular molding areas corresponding to the molding surfaces are set on the first substrate by the master die; and regarding a distance X of the master die in two adjoining molding areas among the plurality of molding areas, letting an area of the master die including a retreated surface of the step and the molding surface be denoted by A (mm²), letting an effective area of the master die corresponding to the molding surface be denoted by B (mm²), letting a thickness of a residual film portion corresponding to a distance between the retreated surface of the step and the flat surface of the first substrate during the third process be denoted by C (mm) and letting a thickness of an effective structure corresponding to an average distance between the molding surface and a bottom surface of a recessed portion which faces the molding surface during the third process be denoted by D (mm), the following relational expression holds:
X≧√{B+(0.05×[B×D+[A−B]×C]+0.005×A)/C}−√A.

3. The method for producing a molding die according to claim 1 wherein, in the third process, the thickness of the residual film portion corresponding to the distance between the retreated surface of the step and the flat surface of the first substrate is shorter than a distance between a portion of the molding surface furthest from the first substrate and the flat surface of the first substrate in the direction vertical to the flat surface.

4. The method for producing a molding die according to claim 1 wherein, in the third process, a position of the molding surface nearest to the first substrate and the flat surface of the first substrate substantially coincide with each other in the direction vertical to the flat surface.

5. The method for producing a molding die according to claim 1 wherein the molding surface of the master die includes a flat flange transfer surface which is provided in the periphery of a portion having a shape corresponding to the shape of the optical lens.

6. The method for producing a molding die according to claim 1 wherein, in the second process, a space between the molding surface and the first substrate is filled with the first resin material disposed on at least one of the master die and the first substrate so that the recessed portion and the step portion are covered with the first resin material by bringing the master die and the first substrate relatively close to each other.

7. A method for producing a molding die wherein a second molding die is obtained by using the resin-made molding die obtained by the method for producing a molding die according to claim 1 as a first molding die, filling a space between the first molding die and a second substrate for molding die with a second resin material; curing the second resin material, and releasing the first molding die.

8. A method for producing a wafer lens comprising a fifth process to obtain a wafer lens which includes a plurality of lens elements formed on a front surface of a third substrate by filling a space between at least one of the second molding die obtained by the method for producing a molding die according to claim 7 and the first molding die obtained by the method for producing a molding die according to claim 1 and the front surface of the third substrate with a third resin material, curing the third resin material, and releasing the first or the second molding die.

9. The method for producing a wafer lens according to claim 8 comprising a sixth process to obtain a wafer lens which includes a plurality of optical lenses formed on a rear surface of the third substrate by filling a space between at least one of the second molding die obtained by the method for producing a molding die according to claim 7 and the first molding die obtained by the method for producing a molding die according to claim 1 and the rear surface of the third substrate with a fourth resin material, curing the fourth resin material, and releasing the first or the second molding die.

10. The method for producing a wafer lens according to claim 9 wherein the sixth process is started before the first or the second molding die is released in the fifth process.

11. A method for producing an optical lens comprising a process to divide by cutting the wafer lens obtained by the method for producing a wafer lens according to claim 8.

12. A method for producing an optical lens comprising a process to divide by cutting the wafer lens obtained by the method for producing a wafer lens according to claim 9.

13. A method for producing an optical lens comprising a process to divide by cutting the wafer lens obtained by the method for producing a wafer lens according to claim 10.

14. The method for producing a molding die according to claim 2 wherein, in the third process, the thickness of the residual film portion corresponding to the distance between the retreated surface of the step and the flat surface of the first substrate is shorter than a distance between a portion of the molding surface furthest from the first substrate and the flat surface of the first substrate in the direction vertical to the flat surface.
